(19) United States
(12) Patent Application Publication
(10) Pub. No.: US 2004/0224267 A1
(43) Pub. Date: Nov. 11, 2004

(54) Silver halide photographic emulsion and silver halide color photographic material

(75) Inventor: Hiroaki Itoh, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Photo Imaging, Inc., Tokyo (JP)

(21) Appl. No.: 10/833,856

(22) Filed: Apr. 28, 2004

(30) Foreign Application Priority Data
May 6, 2003 (JP) JP2003-127930

(51) Int. Cl. G03C 5/18

(52) U.S. Cl. 430/567

(57) ABSTRACT

A silver halide emulsion is disclosed, comprising silver halide grain, wherein the silver halide emulsion is subjected to spectral sensitization by adding a sensitizing dye and further subjected to chemical sensitization by adding a chemical sensitizer, the emulsion contains at least one alkaline earth metal salt selected from the group consisting of a magnesium salt, calcium salt and a strontium salt and a compound having a function of permitting injection of at least one electron into silver halide upon reaction with an oxidized sensitizing dye or a valence band hole.

### FIELD OF THE INVENTION

The present invention relates to a silver halide photographic emulsion and a silver halide color photographic material, and in particular, to a silver halide photographic emulsion exhibiting enhanced sensitivity, reduced fogging and superior thermal storage stability and a silver halide color photographic material by use thereof.

### BACKGROUND OF THE INVENTION

Silver halide photographic materials (hereinafter, also referred to simply as photographic materials) are said to be a highly finished mature product of which various performance is required, such as high speed, enhanced image quality and little variation of performance on storage so that the required level has become more and more increased recently. Specifically, along with recent technical progress in digital cameras, further enhanced performance in speed and image quality has been demanded to maintain superiority of silver halide photographic materials.

Recent techniques for enhancing speed or image quality have been focused onto effective employment of photons incident to the color photosensitive layer. As an approach thereof, a technique enabling to inject at least two electrons through photoexcitation by a single photon has been studied in expectation of a doubled sensitization effect. In commonly known reduction sensitization, for example, a reduction sensitization center traps a hole produced by a single photon and further injects one more electron into a silver halide grain via an oxidation-reduction reaction. Recombination of charges separated by photoexcitation is the greatest loss in the process of latent image formation. Prevention of such a loss and employment of its energy enables injection of one more electron, leading to release of two electrons by a single photon.

Recently, there has been noted a compound exhibiting the function of injecting one or more electrons into silver halide, which originates from reaction with a photoexcited or oxidized sensitizing dye, or a positive hole produced in the valence band. The compound not only injects two electrons into silver halide per absorbed photon but also reduces the loss stage of the recombination of produced electrons with the oxidized sensitizing dye or the positive hole of silver halide, thereby enhancing sensitivity of a silver halide emulsion. The function and the reaction mechanism of the compound are detailed in Nature 402, 865 (1999); and Journal of American Chemical Society 122, 11934 (2000). Techniques employing the foregoing compounds are disclosed in U.S. Pat. Nos. 5,747,236, 6,010,841, 6,054,260 and 6,153,371; JP-A No. 11-237710 (hereinafter, the term JP-A refers to unexamined Japanese Patent Application Publication). As a result of extensive studies by the inventor of this application, it was found that organic compounds capable of forming a (n+m)-valent cation from an n-valent cation radical through an intramolecular cyclization reaction (in which “n” and “m” are each an integer of 1 or more), as described in Journal of the Society of Organic Synthesis Chemistry, Japan (Yuki Gosei Kagaku Kyokaishi), 49 [7] 636-644 (1991) exhibited a similar function when incorporated into a silver halide emulsion. These compounds are detailed in JP-A Nos. 2001-235825 and 2002-72396 with respect to the structure and techniques by use thereof.

However, it was also proved that incorporation of the foregoing compounds into a spectrally sensitized silver halide emulsion resulted in increased fogging and marked variation in performance on heat-standing, making it difficult to achieve enhanced sensitivity. There has been desired a technique to achieve antifogging and improved digestion stability.

### SUMMARY OF THE INVENTION

Accordingly, it is an object of this invention to provide a silver halide photographic emulsion exhibiting enhanced sensitivity, reduced fogging and superior thermal storage stability and a silver halide color photographic material by use thereof.

The foregoing object of this invention can be accomplished by the following constitution. Thus, in one aspect this invention is directed to a silver halide emulsion comprising silver halide grains, wherein the silver halide emulsion is subjected to spectral sensitization by adding a sensitizing dye and further subjected to chemical sensitization by adding at least one chemical sensitizer, the emulsion contains at least one alkaline earth metal salt selected from the group consisting of a magnesium salt, calcium salt and a strontium salt and a compound having a function of permitting injection of at least one electron into silver halide upon reaction with an oxidized sensitizing dye or a valence band hole.

In another aspect, this invention is directed a silver halide color photographic material comprising a support having thereon a red-sensitive layer, a green-sensitive layer, a blue-sensitive layer and a light-insensitive layer, wherein at least one of the red-sensitive, green-sensitive and blue-sensitive layers comprises a silver halide emulsion as described above.

### DETAILED DESCRIPTION OF THE INVENTION

In the invention, the silver halide emulsion contains a compound having a function of permitting injection of at least one electron into silver halide upon reaction with an oxidized sensitizing dye or a valence band hole. In conventional photographic emulsions, a sensitizing dye is excited through photo-excitation by absorption of a single photon, whereby a single electron is injected into the conduction band of silver halide, along with formation of an oxidized sensitizing dye. It is contemplated that repeated events of this type lead to formation of a developable, stable center, called a latent image. Even in an emulsion containing no sensitizing dye, similarly, excitation by a single photon forms a single electron in the conduction band and a positive hole is concurrently formed in the valence band. After having injected a single electron into the conduction band of silver halide through excitation by a single photon, the above-described compound exhibits the function of permitting injection of at least one or more electron into the conduction band of silver halide upon reaction with the oxidized sensitizing dye or the hole in the valence band (valence band hole). In addition to doubling the number of electrons obtained by one photon, the compound contributes to an enhancement in sensitivity of the photographic emulsion by minimizing the loss process due to recombination of the formed electron with the oxidized dye or a positive hole. The function and reaction mechanism of the compound are detailed in Nature, 402, page 865 (1999); and J. Am. Chem. Soc., vol. 122, page 11934 (2000).

The compound having a function of permitting injection of at least one electron into silver halide upon reaction with an oxidized sensitizing dye or a valence band hole preferably exhibits 0.3 to 1.0 V of an oxidation potential which was electrochemically determined before reacting with an oxidized sensitizing dye or a valence band hole, and more preferably 0.3 to 1.0 V. Further, the oxidation potential electrochemically determined after reacting with an oxidized sensitizing dye or a valence band hole is preferably −0.4 to −2.0, more preferably −0.7 to −2.0 V, and still more preferably −0.9 to −1.6 V. The oxidation potential electrochemically determined is represented in terms of an electric potential versus a saturated calomel electrode.

The foregoing compound which has a function of permitting injection of at least one electron into silver halide upon reaction with an oxidized sensitizing dye or a valence band hole, is preferably is an organic compound capable of forming a cation having a valence of (m+n), i.e., an (m+n)-valent cation, from a cation radical having a valence of n (i.e., an n-valent cation radical) with an intramolecular cyclization reaction or an intramolecular transannular reaction, in which n and m each represent an integer of 1 or more. Specifically, n and m preferably are each 1 and an organic compound forming a bivalent cation with an intramolecular cyclization reaction or an intramolecular transannular reaction is more preferred. Of the intramolecular cyclization and transannular reactions, an intramolecular transannular reaction is preferred. An example of an intramolecular transannular reaction is schematically shown below:

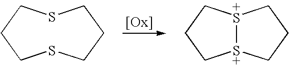

The compound capable of forming an (m+n)-valent cation, from an n-valent cation radical with an intramolecular cyclization reaction or an intramolecular transannular reaction is preferably compounds represented by the following formulas:

A¹—X¹—B¹—X²—A² formula (1)

wherein X¹ and X² are each independently N atom, P atom, S atom, Se atom or Te atom; A¹ and A² are each independently a substituent; and B¹ is a bivalent linkage group;

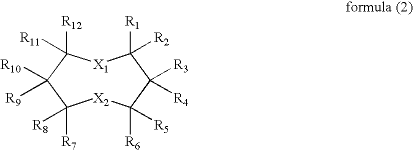

wherein X₁ and X₂ each represent a sulfur atom, selenium atom or tellurium atom; R₁ through R₁₂ each represent a hydrogen atom, an aliphatic group, an aromatic group, a non-metallic atom group necessary to form a ring between R₁ and R₂, R₃ and R₄, R₅ and R₆, R₇ and R₈, R₉ and R₁₀, or R₁₁, and R₁₂, or a non-metallic atom group necessary to form a condensed ring between R₁ and R₃ or R₄, R₂ and R₃ or R₄, R₃ and R₅ or R₆, R₄ and R₅ or R₆, R₅ and R₇ or R₈, R6 and R₇ or R₈, R₇ and R₉ or R₁₀, R₈ and R₉ or R₁₀, R₉ and R₁₁, or R₁₂, R₁₀ and R₁₁ or R₁₂, R₁ and R₁₁ or R₁₂, or R₂ and R₁₁ or R₁₂, provided that when the condensed ring is a unsaturated one, a binding carbon atom at a site forming the condensed ring may form a double bond;

(Z—)ₖ₁—[—(—L—)ₖ₃—X]ₖ₂ formula (3)

wherein Z is an adsorption group onto silver halide (or group promoting adsorption onto silver halide grains) or light absorbing group; L is a bivalent linkage group; X is a group having a moiety structure of the compound capable of forming a (m+n)-valent cation from an n-valent cation radical with an intramolecular cyclization reaction, group having a moiety structure of formula (1) or a group having a moiety structure of formula (2): k₁ is an integer of 1 through 4, k2 is an integer of 1 through 4, and k3 is 0 or 1. The light absorbing group represented by “Z” of the foregoing formula (3) may be any methine dye, and preferred examples thereof include a cyanine dye, merocyanine dye, rhodacyanine dye, three-nucleus merocyanine dye, holopolar dye, hemicyanine dye and styryl dye.

These compounds are detailed in JP-A No. 2001-235825 and japanese Patent Application Nos. 2000-262968, 2001-33493 and 2001-315108, with respect to their structures and techniques for using them. Specific examples of the foregoing compounds are shown below but are by no means limited to these.

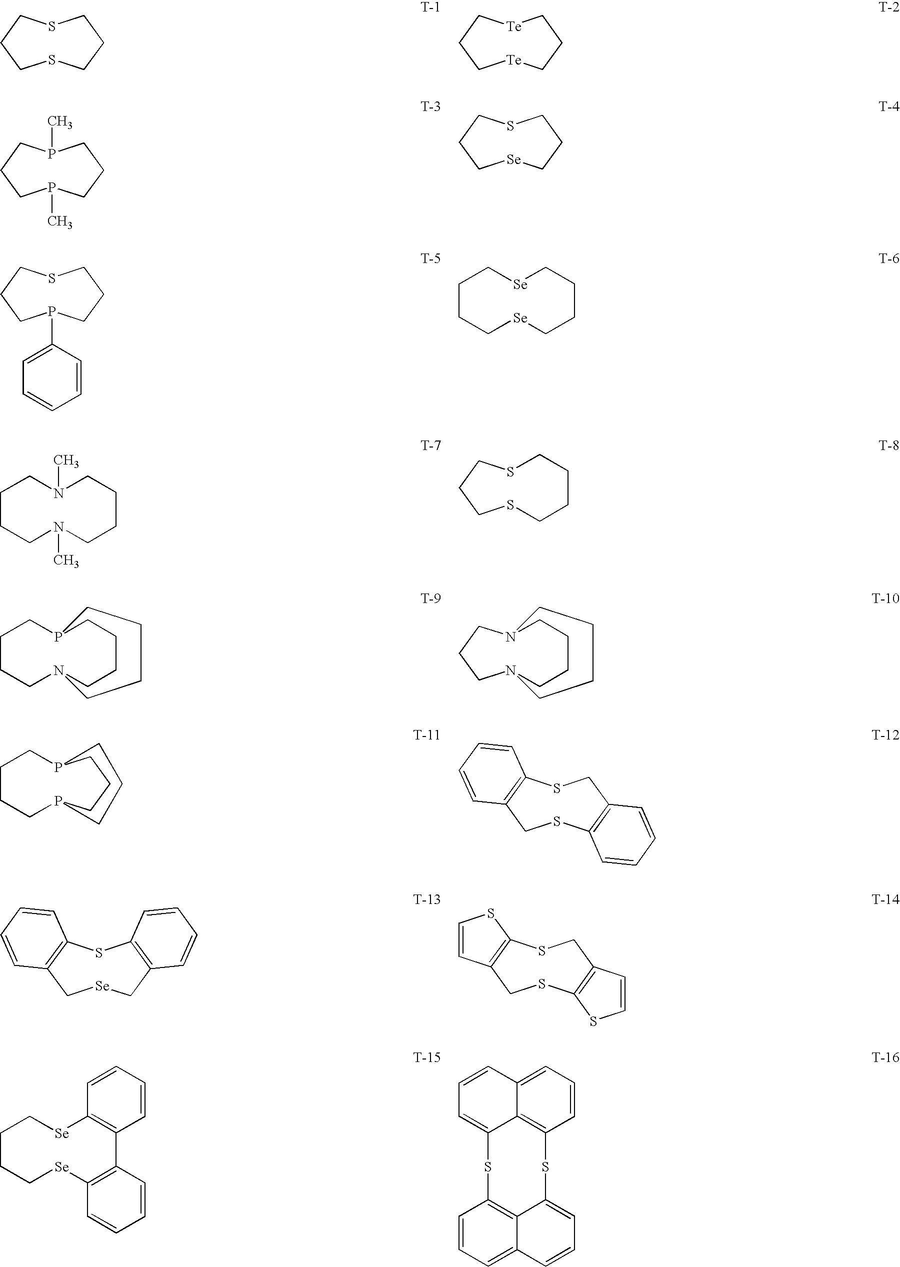

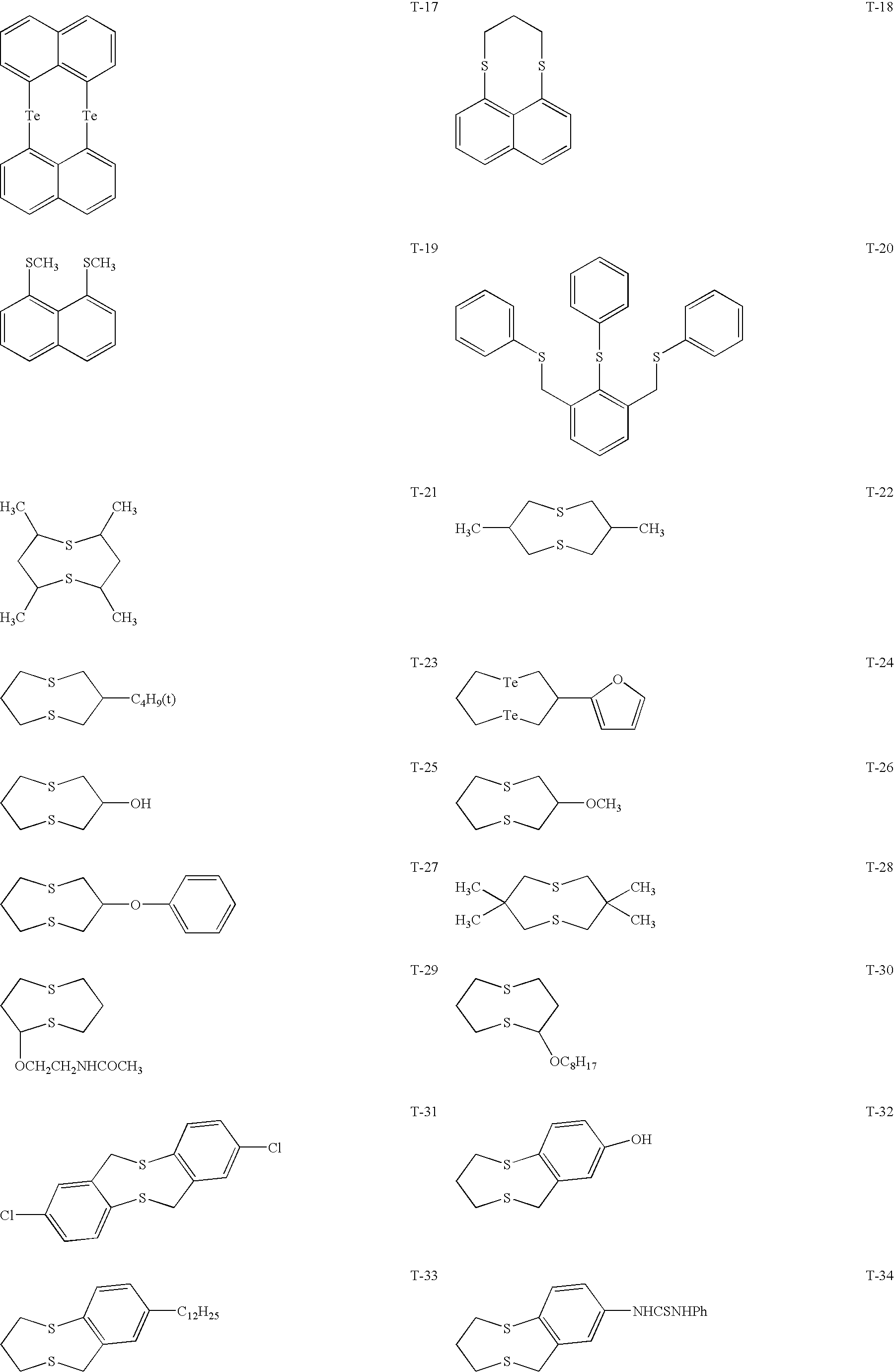

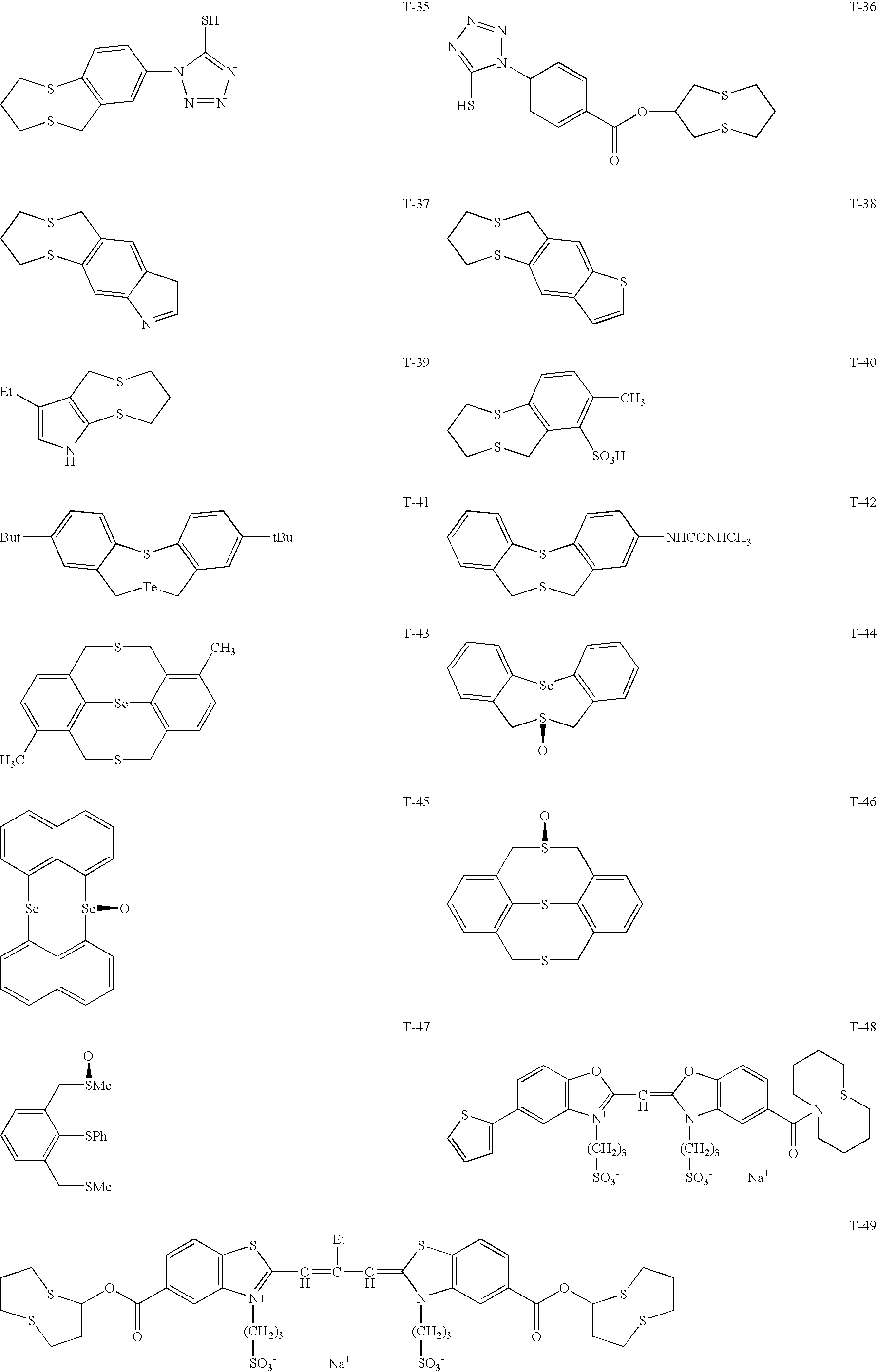

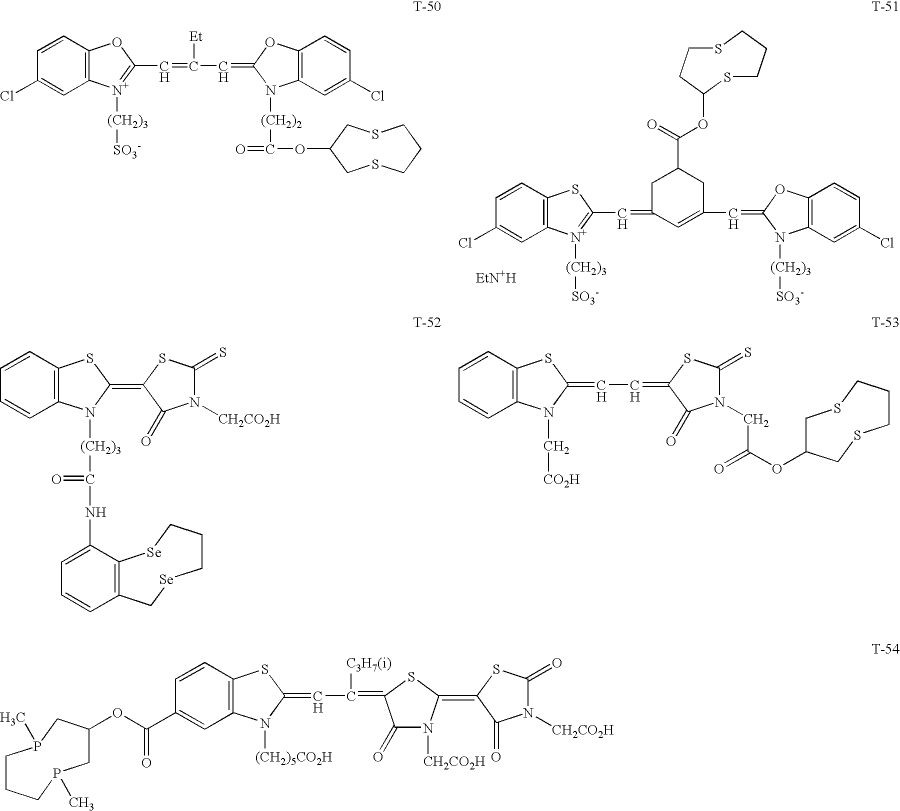

The foregoing compounds may be added to a silver halide emulsion at any stage of emulsion making. As described in U.S. Pat. Nos. 2,735,766, 3,628,960, 4,183,756, 4,225,666; JP-A Nos. 58-184142, and 60-196749, for example, the compound may be added during formation of silver halide grains, before, during desalting, or after desalting and before starting chemical ripening, as described in JP-A No. 58-113920, immediately before or during chemical ripening, or after chemical ripening and before emulsion coating. As described in U.S. Pat. No. 4,225,666 and JP-A No. 58-7629, the compound, alone or in combination with a compound different in structure, may be fractionally added, for example, during the stage of grain formation and during the stage of or after completion of chemical ripening, or before or during chemical ripening and after chemical ripening. The compound is added preferably after completion of spectral sensitization and chemical sensitization, and before addition of a stabilizer.

The organic compound capable of forming a (m+n)-valent cation from an n-valent cation radical with an intramolecular cyclization reaction or intramolecular transannular reaction may be incorporated in any amount. When the compound has no adsorption group onto silver halide, the amount is preferably 10⁻⁵ to 10−1 mol per mol of silver halide; and in the case of the compound having an adsorption group onto silver halide, the amount is preferably 10⁻⁶ to 10⁻² mol per mol of silver halide.

A silver halide emulsion relating to this invention preferably contain a hydroxybenzene compound. The hydroxybenzene compound is represented, for example, by the following formula:

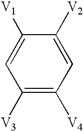

wherein V₁, V₂, V₃ and V₄ are each independently H, OH, a halogen atom, OM (in which M is an alkali metal ion), alkyl group, phenyl group, amino group, carboxyl group, carbonyl group, sulfone group, sulfonated phenyl group, sulfonated alkyl group, sulfonated amino group, carboxyphenyl group, hydroxyphenyl group, carboxyalkyl group, carboxyamino group, hydroxyphenyl group, hydroxyalkyl group, alkyl ether group, alkyl phenyl group, alkyl thioether group or phenyl thioether group, provided that at least two of V₁, V₂, V₃ and V₄ are OH or OM. Specifically, V₁, V₂, V₃ and V₄ are preferably H, OH, Cl, Br, COOH, CH₂CH₂COOH, CH₃, CH₂CH₃, C(CH₃)₃, OCH₃, CHO, SO₃Na, SO_{3H, SCH}₃ and phenyl group, provided that at least two of V₁, V₂, V₃ and V₄ are OH.

Specifically preferred hydroxybenzene compounds are as follows;

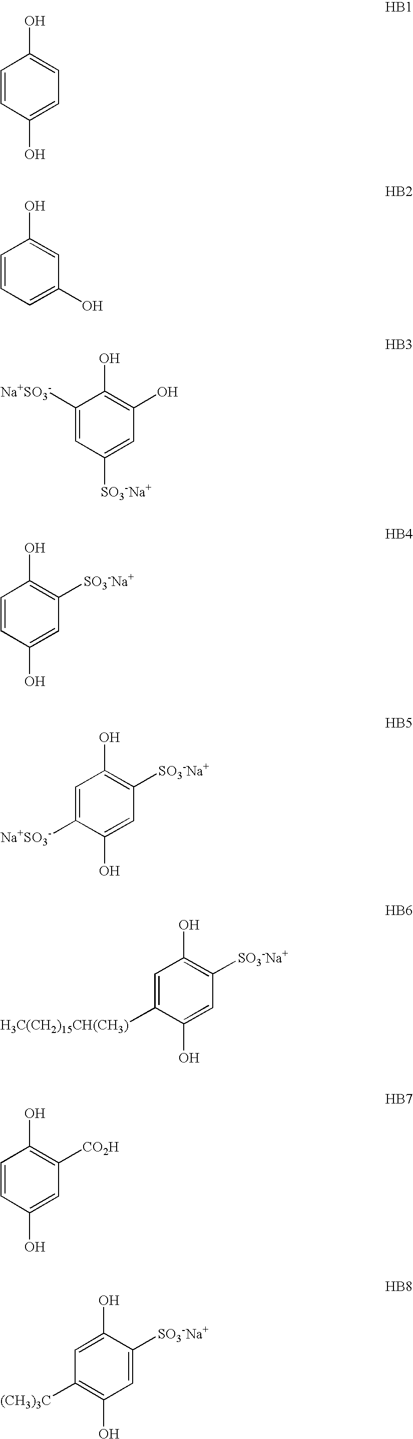

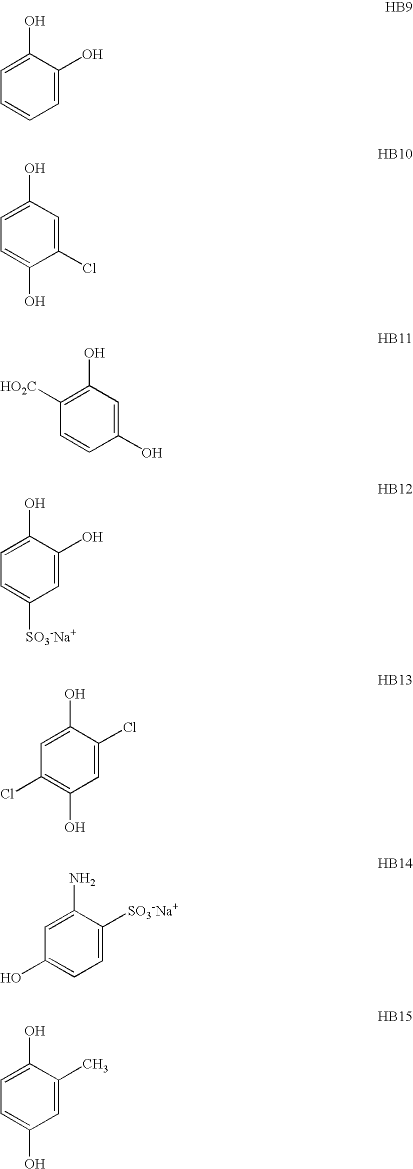

Further to the foregoing, compounds represented by general formulas (IV-1) and (IV-2) of JP-A No. 2001-42466 are also include and as exemplary compounds thereof are preferably used compounds IV-1-1 through IV-2-4 disclosed in col. 0191 through 0224 of JP-A 2001-42466. The foregoing hydroxybenzene compound may be incorporated in the emulsion layer relating to the invention or any component layer of the photographic material relating to the invention. The compound is added preferably in an amount of 1×10⁻³ to 1×10⁻¹ mol, and more preferably 1×10⁻³ to 1×10⁻² mol per mol of silver halide.

To effect this invention, addition of a sensitizing dye to a silver halide emulsion achieves spectral sensitization, followed by addition of at least one of a magnesium salt, calcium salt and strontium salt selected from alkaline earth metal salts and the silver halide emulsion is subjected to an appropriate chemical sensitization including a chalcogen sensitization.

Of alkaline earth metal salts to be added, at least one is selected from a magnesium salt, a calcium salt and a strontium salt. Of these, a calcium salt is the most preferable, and strontium salt and a magnesium salt is preferable in this order. The foregoing alkaline earth metal salt is added preferably after adding a spectral sensitizing dye to allow the dye to be sufficiently adsorbed onto the silver halide grain surface and before subjecting to an appropriate chemical sensitization including a chalcogen sensitization. The salt is added preferably in an amount of 1×10⁻⁴ to 1×10⁻² mol per mol of silver halide. The salt is preferably water-soluble, an a nitrate or chloride salt is preferred. Example thereof include calcium nitrate, calcium chloride, magnesium nitrate, magnesium chloride and strontium nitrate, and of these, calcium nitrate is preferred.

The silver halide emulsion relating to this invention is subjected to an appropriate chemical sensitization including a chalcogen sensitization. The appropriate chemical sensitization including a chalcogen sensitization refers to at least one of chalcogen sensitization such as sulfur sensitization, selenium sensitization or tellurium sensitization, and noble metal sensitization such as gold sensitization, palladium sensitization and other noble metal sensitizations. In this invention, chalcogen sensitization is preferably conducted using chalcogen sensitizers such as sulfur sensitizers, selenium sensitizers and tellurium sensitizers. Of the chalcogen sensitizers, the of sulfur sensitizers or selenium sensitizers is specifically prefrred. The chemical sensitization is conducted at any stage in the process of preparing a silver halide emulsion. A combination of at least two types of chemical sensitizations is preferred. At which stage is conducted chemical sensitization can prepare various types of emulsions, including a type of chemical sensitization specks (or centers) being occluded in the interior of the grain, a type of being occluded at a relatively shallow position from the grain surface and a type of chemical sensitization specks being formed on the grain surface. The position of chemical sensitization specks is chosen depending on the objective emulsion. It is generally preferred to form chemical sensitization specks near the grain surface.

Preferred chemical sensitization to be conducted in this invention is chalcogen sensitization and noble metal sensitization, alone or in combination, which can be conducted using an active gelatin, as described in T. H. James, The Theory of the Photographic Process, 4th ed., Macmillan (1977) or at a pAg of 5 to 10 and a pH of 5 to 8 using a sulfur, tellurium, gold, platinum or palladium sensitizer or combinations of a plurality of these sensitizers, as described in Research Disclosure vol. 120 (April, 1974) 12008; ibid vol. 34 (June, 1975) 13452; U.S. Pat. Nos. 2,642,361, 3,297,446, 3,773,031, 3,857,711, 3,901,714, 4,226,018 and 3,904,415; and British patent No. 1,315,755. Noble metal sensitization can use noble metals such as gold, platinum and palladium, and gold sensitization, palladium sensitization or the combination thereof is preferred.

In gold sensitization, commonly known compounds such as chloroauric acid, potassium chloroaurate, potassium auriothiocyanate, gold sulfide and gold selenide are usable as a gold sensitizer. Palladium compounds usable in this invention include a bi-valent salt and tetra-valent salt. Preferred palladium compounds are represented by the formula of R₂PdX₆ or R₂PdX₄, in which R is a hydrogen atom, an alkali metal atom or an ammonium group; X is a halogen atom such as chlorine, bromine or iodine atom. Specific preferred examples thereof include K₂PdCl₄, (NH₄)₂PdCl₆, Na₂PdCl₄, (NH₄)₂PdCl₄, Li₂PdCl₄, Na₂PdCl₆ and K₂PdBr₄. The foregoing gold compounds and palladium compounds are used preferably in combination with thiocyanates or selenocyanates.

Sulfur sensitization can be conducted in the presence of sensitizers such as hypo (sodium thiosulfate), thiourea compounds, rhodanine compounds and sulfur compounds described in U.S. Pat. Nos. 3,857,711 and 4,226,018. Compounds such as azaindene, azapyridazine and azapyrimidine are also usable as a chemical-sensitizing aid to inhibit fogging and enhance sensitivity in the course of chemical sensitization. Specific examples of such a chemical-sensitizing aid are described in U.S. Pat. Nos. 2,131,038, 3,411,914 and 3,554,757; JP-A No. 58-126526 and Duffin, Photographic Emulsion Chemistry, page 138-143.

Gold sensitization is preferably employed in silver halide grain emulsions relating to this invention. A gold sensitizer is used preferably in an amount of 1×10⁻⁷ to 1×10⁻⁴ mol and more preferably 5×10⁻⁷ to 1×10⁻⁵ mol per mol of silver halide. Palladium compounds are used in an amount of 5×10^{31 7} to 1×10⁻³ mol per mol of silver halide. Thiocyanate compounds or selenocyanate compounds are used preferably in an amount of 1×10⁻⁶ to 5×10⁻² mol per mol of silver halide. Sulfur sensitizers are used preferably in an amount of 1×10⁻⁷ to 1×10⁻⁴ mol and more preferably 5×10⁻⁷ to 1×10⁻⁵ mol per mol of silver halide.

Selenium sensitization is also preferably used in silver halide emulsions relating to this invention. Commonly known labile selenium compounds are used as a selenium sensitizer. Specific examples thereof include colloidal metallic selenium, selenoureas (e.g., N,N-dimethylselenourea, N,N-diethylselenourea), selenoketones and selenoamides. Selenium sensitization is often used in combination with sulfur sensitization or noble metal sensitization.

Tellurium sensitization is also usable in this invention using a tellurium sensitizer, such as tellurium compounds analogous to the foregoing selenium compounds, such as colloidal tellurium, telluroureas, telluroketons and telluroamides.

A variety of compounds are used in silver halide emulsions relating to this invention to inhibit fogging caused in the course of preparation and storage of photographic materials and stabilize photographic performance. Thus, a number of compounds known as an antifoggant or a stabilizer are incorporated into silver halide emulsions relating to this invention. Examples thereof include thiasols such as benzthiazolium salts, nitroimidazoles, nitrobenzimidazoles, chlorobenzimidazoles, bromobenzimidazoles, mercaptothiazoles, mercaptobenzthiazoles, mercaptobenzimidazoles, mercaptothiadiazoles, aminotriazoles, benztriazoles, nitrobenztriazoles, mercaptotetrazoles (specifically, 1-phenyl-5-mercaptptetrazole), mercaptopyrimidines, mercaptotriazine, thiketone compounds such as oxazolinethione, and azaindenes such as triazaindenes, tetrazaindenes (specifically, 4-hydroxy-1,3,3a,7-tetrazaindene) and pentazaindens. There are also usable compounds described in U.S. Pat. Nos. 3,954,474 and 3,982,947 and JP-B No. 52-28660 (the term JP-B refers to Japanese Patent Publication). Compounds described in JP-A No. 63-212932 are preferably used. Antifoggants or stabilizers may be added at any time before, during or after grain formation, at the stage of washing or dispersing after washing, before, during or after chemical sensitization, and before coating. In addition to the addition during emulsion making to manifest anti-fogging and stabilization effects, the foregoing compounds may be used to control crystal habit of the grains, to retard the grain growth, to reduce solubility of the grains, to control chemical sensitization and to control the arrangement of sensitizing dyes.

Spectral-sensitizing dyes to be adsorbed onto silver halide grains include methine dyes. Thus, silver halide emulsions relating to this invention are spectrally sensitized preferably using methine dyes or the like. Examples of dyes usable in this invention include cyanine dyes, merocyanine dyes, complex cyanine dyes, complex merocyanine dyes, holopolar cyanine dyes, hemi-cyanine dyes, styryl dyes and hemi-oxonol dyes. Of these dyes, cyanine dyes, merocyanine dyes and complex merocyanine dyes are specifically useful. In the dyes described above, any nucleus used in cyanine dyes is applicable as a basic heterocyclic nucleus. Examples thereof include a pyrroline nucleus, oxazoline nucleus, oxazole nucleus, thiazole nucleus, selenazole v, imidazole nucleus, tetrazole nucleus, pyridine nucleus, and the above-described nucleuses condensed with an alicyclic hydrocarbon ring or aromatic hydrocarbon ring, such as indolenine nucleus, benzindolenine nucleus, indole nucleus, benzoxazole nucleus, naphthoxazole nucleus, benzothiazole nucleus, naphthothiazole nucleus, benzoselenazole nucleus, benzimidazole nucleus, and quinoline nucleus. The foregoing nucleuses may be substituted on carbon atoms. In merocyanine dyes and complex merocyanine dyes, 5- or 6-membered heterocyclic nucleuses are used, including pyrazoline-5-one nucleus, thiohydantoin nucleus, 2-thiooxazoline-2,4-dione nucleus, thiazolidine-2,4-dione v, rhodanine nucleus and thiobarbituric acid nucleus.

The sensitizing dyes described above may be used alone or in combination. A combination of sensitizing dyes is often used for the purpose of supersensitization. Representative examples thereof are described in U.S. Pat. Nos. 2,688,545, 2,977,229, 3,397,060, 3,522,052, 3,527,641, 3,617,293, 3,628,964, 3,666,4803,672,898, 3,679,428, 3,703,377, 3,769,301, 3,814,609, 3,837, 862 and 4,026,707; British patent Nos. 1,344,281 and 1,507,803; JP-B Nos. 43-4936 and 53-12375; JP-A Nos. 52-110618 and 52-109925. Dyes exhibiting no spectral sensitization or substances absorbing no visible light which exhibit supersensitization may be incorporated together with sensitizing dyes into a silver halide emulsion.

Sensitizing dyes usable in the silver halide emulsion relating to this invention may be added after formation of silver halide grains or before adding fine grains and usually added after completion of chemical sensitization and before coating. Sensitizing dyes may be added with chemical sensitizers to concurrently perform spectral sensitization and chemical sensitization, as described in U.S. Pat. Nos. 3,628,969 and 4,225,666. Sensitizing dyes may be added prior to chemical sensitization, as described in JP-A No. 58-113928 or before completion of formation of silver halide grains. The foregoing compound may be dividedly added, as described in U.S. Pat. No. 4,255,666. Thus, a part of the compound can be added prior to chemical sensitization and the remainder thereof is added after chemical sensitization. Addition may be conducted during the formation of silver halide grains, as described in U.S. Pat. No. 4,183,755.

A sensitizing dye is added in an amount of 4×10⁻⁶ to 8×10⁻³ mol per mol of silver halide, and 5×10⁻⁵ to 2×10⁻³ mol is preferred for silver halide grains of 0.2 to 1.2 μm. Various additives can be used to prepare a photographic material using the silver halide emulsion of this invention. In addition thereto, various additives can be added in accordance with objectives. These additives are described in Research Disclosure item 17643 (December 1978), ibid, item 18716 (November, 1979), and ibid, item 308119 (December 1989).

Silver halide emulsions relating to this invention are those comprising tabular silver halide grains (hereinafter, also denoted simply as tabular grains) having two twinned planes. The tabular grains are crystallographically classified as twinned crystal grains. The twinned crystal grains refer to crystal grains having at least one twin plane within the grain. Classification of silver halide twinned crystal grains is described in Klein & Moisar's report (Photographishe Korrespondenz, vol. 99, page 99, and vol. 100, page 57). Tabular grains relating to the invention are those having at least two twinned planes parallel to the major faces.

The twin plane can be observed directly with a transmission electron microscope. Thus, a photographic emulsion is coated on a support to prepare a sample so that the major face of tabular grains contained are arranged parallel to the support surface. The thus prepared sample is cut using a diamond cutter to obtain ca. 0.1 μm thick slices. The presence of twin plane(s) can be confirmed through observation of this slice using a transmission electron microscope. In the invention, the spacing between two twin planes of the tabular grains is determined in such a manner that in the foregoing transmission electron microscopic observation of the slice, at least 100 tabular grains exhibiting a section vertical to the major faces are selected, then, the shortest spacing between two twin planes that are closest to the major face among even numbers of twin planes parallel to the major face is determined for each grain and the thus obtained shortest spacings are averaged for total grains to determine the spacing between twin planes as defined in the invention. The spacing between two twin planes (hereinafter, also called a twin plane spacing) is preferably not more than 0.01 μm.

One aspect of the silver halide emulsion of the invention is that at least 50% of the total grain projected area of the emulsion is accounted for by tabular grains having an aspect ratio of 10 to 100. Preferably, at least 60% of the total grain projected area, more preferably at least 70% and still more preferably at least 80% is accounted fro by tabular more preferably 10 to 50. The aspect ratio is defined as the ratio of grain diameter to grain thickness (i.e., aspect ratio=grain diameter/grain thickness). The grain diameter means the diameter of a circle having the same area as that of a grain projected vertically to the major face, i.e., projected area (hereinafter, also denoted as an equivalent circle diameter or abbreviated as ECD).

The diameter, thickness and aspect ratio of a tabular grain can be determined in the following manner (replica technique). Thus, a coating sample is prepared by coating silver halide grains and latex balls having a known diameter as an internal standard to prepare a sample on a substrate of a film support so that the major faces of the grains are arranged parallel to the substrate. After subjecting the sample to shadowing at a given angle by carbon vacuum evaporation, a replica sample is prepared by a conventional replica technique. An electron micrograph of this sample is taken and the projected area and thickness are determined for each grain using an image processing apparatus. In this case, the grain projected area can be calculated from the projected area of the internal standard and the grain thickness can also be calculated from the internal standard and the shadow length of the grain. In the invention, the average aspect ratio is an average value by number of aspect ratios of at least 30 grains.

In one preferred embodiment of the invention, a coefficient of variation (hereinafter, also denoted as a variation coefficient) of grain diameter (i.e., equivalent circle diameter) of total grains is less than 35%. This variation coefficient, which is a value indicating a grain size distribution or a degree of grain size dispersibility, is preferably less than 30% and more preferably less than 25%. The variation coefficient of equivalent circle diameter is a value defined in accordance with the following equation, which can be determined by the measurement of equivalent circle diameter of at least 300 grains randomly selected:

Variation coefficient of equivalent circle diameter (%)=(standard deviation of equivalent circle diameter)/(mean value of equivalent circle diameter)×100.

One aspect of the silver halide emulsion relating to the invention is that at least 50% by number of total grains is accounted for by tabular grains having at least 30 dislocation lines per grain, in the fringe portion of the grain. The tabular grains having at least 30 dislocation lines per grain in the fringe portion preferably accounts for at least 60% by number of the total grains, more preferably at least 70% by number, and still more preferably at least 80% by number. The number of dislocation lines per grain is preferably 30 to 1000, and more preferably 30 to 300.

The dislocation lines in silver halide grains can be directly observed by means of transmission electron microscopy at a low temperature, for example, in accordance with methods described in J. F. Hamilton, Phot. Sci. Eng. 11 (1967) 57 and T. Shiozawa, Journal of the Society of Photographic Science and Technology of Japan, 35 (1972) 213. Silver halide tabular grains are taken out from an emulsion while making sure not to exert any pressure that causes dislocation in the grains, and they are then placed on a mesh for electron microscopy. The sample is then observed by transmission electron microscopy, while being cooled to prevent the grain from being damaged by the electron beam. Since electron beam penetration is hampered as the grain thickness increases, sharper observations are obtained when using an electron microscope of higher voltage (e.g., at a voltage 200 kV or more for a 0.25 μm thick grain). From the thus-obtained electron micrograph, the position and number of the dislocation lines in each grain can be determined. Any of several methods for introducing the dislocation lines into the silver halide grain may be used.

In the invention, the expression “having dislocation lines in the fringe portion” means that the dislocation lines exist in the vicinity of the circumferential portion, in the vicinity of the edge or in the vicinity of the corner of the tabular grain. Concretely, when the tabular grain is observed vertical to the major face of the grain and a length of a line connecting the center of the major face (i.e., a center of gravity of the major face, which is regarded as a two-dimensional figure) and a corner is represented by “L”, the fringe portion refers to the region outside the figure connecting points at a distance of 0.50L from the center with respect to the respective corners of the grain.

The dislocation lines can be introduced by various methods, in which, at a desired position of introducing the dislocation lines during the course of forming silver halide grains, an aqueous iodide (e.g., potassium iodide) solution is added, along with an aqueous silver salt (e.g., silver nitrate) solution by a double jet technique, only an iodide solution is added, an iodide-containing fine grain emulsion is added or an iodide ion releasing agent is employed, as disclosed in JP-A No. 6-11781. Specifically, it is preferred to introduce dislocation lines into the silver halide grains relating to the invention by the use of an iodide ion releasing compound. The iodide ion releasing agent, which is a compound capable of releasing an iodide ion upon reaction with a base or a nucleophilic reagent is represented by the following formula:

R—I

where R is a univalent organic group. The iodide ion releasing agents (R-I) are preferably iodo-alkanes, a iodo-alcohol, iodo-carboxylic acid, iodo-amid, and their derivatives, more preferably iodo-amide, iodo-alcohol and their derivatives, still more preferably iodo-amide substituted by a heterocyclic group, and specifically preferable examples include (iodoacetoamido)bebzenesulfonate.

When the iodide ion releasing agent is reacted with a nucleophilic agent (or nucleophile) to release an iodide ion, preferred nucleophilic agents include, for example, preferred nucleophilic agents include hydroxy ion and sulfite ion.

When dislocation lines are introduced into silver halide emulsion grains using the iodide ion releasing agent, preferred reaction conditions are as follows. Thus, the reaction temperature is preferably 30 to 800° C.,and more preferably 40 to 700° C. The pAg immediately before introduction of dislocation lines is preferably 7.0 to 10.0, and more preferably 7.5 to 9.5. The iodide ion-releasing agent is added preferably in an amount of 1 to 5 mol %, based on the total amount of silver halide. The pH at the time of an iodide ion releasing reaction is preferably 7.0 to 11.0, and more preferably 8.0 to 10.0. In cases when a nucleophilic agents other than a hydroxy ion, the amount thereof is preferably 0.25 to 2.0 times, more preferably 0.5 to 1.5, and still more preferably 0.8 to 1.2 times that of the iodide ion releasing agent.

In silver halide grain emulsions relating to this invention, silver halide grains preferably have a shallow electron trap center in the interior of the grain. The shallow electron trap center can be provided by doping a dopant represented by the following formula into the silver halide grains:

[ML₆]ⁿ

where M represents a polyvalent metal ion having a filled frontier orbital and L₆ represents independently six coordination complex ligands, provided that at least four of the ligands (L₆) are anion ligands and at least one of the ligands is a ligand more electron-negative than a halide ligand (in other words, the ligand exhibiting a electronnegativity higher than that of a halide ligand); and n is a negative integer (and preferably, −1, −2, −3 or −4). Examples of the dopant providing a shallow electron trap center include SET-1 through SET-27 described in U.S. Pat. No. 5,728,517, as shown below:

SET-1: [Fe(CN)₆]^{4 -}

SET-2: [Ru(CN)₆]⁴⁻

SET-3: [Os(CN)₆]⁴⁻

SET-4: [Rh(CN)₆]³⁻

SET-5: [Ir(CN)₆]³⁻

SET-6: [Fe(pyrazine)(CN)₅]⁴⁻

SET-7: [RuCl(CN)₅]⁴⁻

SET-8: [OsBr(CN)₅]⁴⁻

SET-9: [RhF(CN)₅]³⁻

SET-10: [IrBr(CN)₅]³⁻

SET-11: [FeCO(CN)₅]³⁻

SET-12: [RuF₂(CN)₄]⁴⁻

SET-13: [OsCl₂(CN)₄]⁴⁻

SET-14: [RhI₂ (CN)4₅]³⁻

SET-15: [IrBr₂(CN)₄]³⁻

SET-16: [Ru(CN)₅(OCN)]⁴⁻

SET-17: [Ru(CN)₅(N₃)]-⁴⁻

SET-18: [Os(CN)₅(SCN)]⁴⁻

SET-19: [Rh(CN)₅(SeCN)]³⁻

SET-20: [Ir(CN)₅(HOH)]²⁻

SET-21: [Fe(CN)₃Cl₃]³⁻⁾

SET-22: [Ru(CO)₂(CN)₄]¹⁻

SET-23: [Os(CN)(CN)₅]⁴⁻

SET-24: [Co(CN)₆]³⁻

SET-25: [Ir(CN)₄(oxalate)₂]³⁻

SET-26: [In(NCS)₆]³⁻

SET-27: [Ga(NCS)₆]³⁻

The dopant may be added in the form of a solution or a fine silver halide grain emulsion doped with a dopant. The dopant is added in an amount of 10⁻⁶ to 10⁻³ mol, and preferably 10⁻⁵ to 10⁻⁴ mol per mol of silver halide. The dopant is added preferably after forming at least 50% (and more preferably at least 70%) of the grown (or final) grain volume. The dopant is also added preferably at a pAg of 7.5 to 9.5, and more preferably 8.0 to 9.0.

A hole trap center may be formed on combination with the use of the compound having a function of permitting injection of at least one electron into silver halide upon reaction with an oxidized sensitizing dye or a valence band hole. The hole trap center can be provide by subjecting to reduction sensitization at the stage of grain formation. The reduction sensitization can be conducted by adding a reducing agent to a silver halide emulsion or a solution used for grain growth. Examples of preferred reducing agents include thiourea dioxide (formamidine-sulfonic acid), ascorbic acid and its derivatives, and tin (II) salt. Other reducing agents include, for example, borane compounds, hydrazine compounds, silane compounds, amines and polyamines. The reducing agent is added preferably in an amount of 10⁻⁸ to 10⁻² mol, and more preferably. 10⁻⁶ to 10⁻⁴ mol per mol of silver halide.

To control the formation of the hole trap center, it is preferred to add, after completion of reduction sensitization, a compound capable of releasing a chalcogen ion (hereinafter, also denoted as a chalcogen ion releasing compound). Such a chalcogen ion releasing compound is preferably a compound releasing a sulfide ion, selenide ion, or telluride ion. Preferred examples of the compound releasing a sulfide ion include a thiosulfonic acid compound, disulfide compound, thiosulfate compound, sulfide compound and thiosemicarbazide compound, thioformamide compound and a rhodanine compound. Of the foregoing chalcogen ion releasing compounds, thiosulfonic acid compounds are preferred. The chalcogen ion releasing compound is added preferably in an amount of 10⁻⁸ to 10⁻² mol, and more preferably 10⁻⁶ to 10⁻³ mol per mol of silver halide. The chalcogen ion releasing compound may be added instantaneously or added over a period of a given time to perform reduction sensitization, in which the addition thereof may be conducted at a constant flow rate or at an accelerated flow rate. The addition may be dividedly carried out. Addition of the chalcogen ion releasing compound must be conducted before completing grain formation.

The silver halide emulsion is preferably comprised of silver halide grains having a multi-layered structure comprising plural layers different in halide composition. It is preferred to have at least three layers, more preferably at least four layers, and still more preferably at least five layer different in halide composition. Adjacent layers are different in halide composition ratio by at least 1 mol %, and more preferably different in iodide content by at least 1 mol %.

In the preparation of silver halide emulsions relating to the invention, it is preferred to apply ultrafiltration to concentrate an emulsion by ultrafiltration in at least a part of the grain growth stage. In cases when preparing tabular grain emulsions having a relatively high aspect ratio and exhibiting high homogeneity in grain size distribution, such as in the invention, it is preferred to grow grains in a diluted environment so that application of the ultrafiltration is preferable to enhance productivity. When conducting concentration of emulsions by using ultrafiltration, it is also preferred to employ a manufacturing facility of silver halide emulsions, as described in JP-A No. 10-339923.

The silver halide emulsions used in the invention contain a dispersion medium. The dispersion medium is a compound capable of acting as a protective colloid for silver halide grains. It is preferred to allow the dispersion medium to be present from the start of the nucleation stage to completion of grain growth stage. Preferred examples of the dispersion medium include gelatin and hydrophilic colloids. There is preferably used gelatin such as alkali or acid processed gelatin having a molecular weight of the level of 100,000 or enzyme-treated gelatin described in Bull. Soc. Sci. Photo. Japan No. 16, pp. 30 (1966). Examples of the hydrophilic colloid include gelatin derivatives, graft polymers of gelatin and other polymers, proteins such as albumin and casein, cellulose derivatives such as hydroxyethyl cellulose, carboxymethyl cellulose, cellulose sulfuric acid ester, saccharide derivatives such as sodium alginate and starch derivatives and synthetic hydrophilic polymer material including homopolymers such as polyvinyl alcohol, polyvinyl alcohol partial acetal, poly(N-vinyl pyrrolidine), polyacrylic acid, polymethacrylic acid, polyacrylamide, polyvinyl imidazole, and polyvinyl pyrazolo, and their copolymers.

At the stage of nucleation of silver halide grains, it is preferred to use oxidized gelatin, low molecular weight gelatin having a molecular weight of 10,000 to 50,000 and oxidized low molecular weight gelatin. Specifically is preferred an oxidized gelatin, in which methionine residue is reduced by oxidation to a level of less than 30 μmol per gram of gelatin. At the stage of grain growth is preferable oxidized gelatin, in which methionine residue is reduced by oxidation to a level of less than 20 μmol, and more preferably less than 10 mol % per gram of gelatin. Oxidation of alkali-processed gelatin by using oxidizing agents is useful to achieve a methionine content of less than 30 μmol/g. Oxidizing agents to oxidize gelatin include, for example, hydrogen peroxide, ozone, peroxy-acid, halogen, thiosulfonic acid compounds, quinines, and organic peracids. Of these, hydrogen peroxide is preferred. Determination of the methionine content is described in many literatures. Amino acid analysis, HPLC method, gas chromatography and silver ion titrimetry are employed with reference to, for example, Journal of Photographic Science, vol. 28, page 11; ibid, vol. 40, page 149; ibid, vol. 41, page 172; ibid, vol. 42, page 117; and Journal of Imaging Science and Technology, vol. 39, page 367.

At the stage of grain growth is preferable oxidized gelatin, in which methionine residue is reduced by oxidation to a level of less than 20 μmol per gram of gelatin. Chemically modified gelatins include, for example, gelatin, an amino group of which is substituted, as described in JP-A Nos. 5-72658, 9-197595 and 9-251193.

In the emulsion relating to the invention, after completion of silver halide grain growth, soluble salts may be or may not be removed. Desalting can also be conducted at any time during the silver halide grain growth, in such a manner as described in JP-A No. 60-138538. Soluble salts can be removed in accordance with methods described in RD17643, item II. Thus, to remove soluble salts from the emulsion after forming precipitates or completing physical ripening, there may be employed a noodle washing method by chill-setting gelatin or a coagulation washing (flocculation) by using inorganic salts, anionic surfactants, anionic polymers (e.g., polystyrene sulfonic acid, etc.) or gelatin derivatives (e.g., acylated gelatin, carbamoylated gelatin, etc.).

The emulsion of the invention may be used alone in an emulsion layer or may be blended with other emulsion(s) within the range not vitiating effects of the invention. The use of plural emulsions different in average size in the same emulsion layer is one of preferred embodiments.

In emulsion making, conditions other than the foregoing can be optimally selected with reference to JP-A Nos. 61-6643, 61-14630, 61-112142, 62-157024, 62-18556, 63-92942, 63-151618, 63-163451, 63-220238, and 63-311244; RD38957, items I and III, and RD40145, item XV.

In the construction of a color photographic material using the emulsion of the invention, the emulsion having been subjected to physical ripening, chemical ripening and spectral sensitization is used. Additive used in such manufacturing processes are described in RD38957, items IV and V, and RD40145, item XV. Commonly known photographic additives usable in the invention are also described in RD38957, items II through X and RD40145, items I through XIII.

In the constitution of a color photographic material using the silver halide emulsion relating to the invention, red-, green- and blue-sensitive silver halide emulsion layers are provided, each of which contains a coupler. Chromogenic dyes formed of couplers contained in the respective layers exhibit spectral absorption maximums, each of which is preferably at least 20 nm apart from the other. As a preferred coupler, a cyan coupler, magenta coupler and yellow coupler are used. The combination of respective emulsion layers with couplers is usually combinations of a yellow coupler and a blue-sensitive layer, a magenta coupler and a green-sensitive layer, and a cyan coupler and a red-sensitive layer, but is not limited to these combinations and other combinations are applicable.

DIR compounds are used to constitute a color photographic material using the silver halide emulsion relating to the invention. Examples of DIR compounds usable in the invention include D-1 through D-34 described in JP-A No. 4-114153. In addition, there may be used DIR compounds described in U.S. Pat. Nos. 4,234,678, 3,227,554, 3,647,291, 3,958,993, 4,419,886, and 3,933,500; JP-A Nos. 57-56837, and 51-13239; U.S. Pat. Nos. 2,072,363, and 2,070,266; and RD40145 item XIV.

Examples of coupler usable in the construction of a color photographic material by using the emulsions of the invention are described in RD40145, item II. Additives usable in the construction of a color photographic material by using the emulsions of the invention can be incorporated by the dispersing method described in RD40145, item VIII. Commonly known supports described in RD38957, item XV can be used in the photographic material using the emulsions of the invention. The photographic material may be provided with an auxiliary layer such as a filter layer or an interlayer, as described in RD38957, item XI. There are applicable various layer configurations, such as conventional layer order, reverse layer order, or unit construction, as described in RD38957, item XI.

Silver halide emulsions relating to the invention are preferably applicable to various color photographic materials, such as color negative films for general use or for use in movie, color reversal films for slide or for television, color paper, color positive films and color reversal paper.

The photographic material using the emulsions of the invention can be processed using commonly known developers described in T. H. James “The Theory of The Photographic Process” Forth Edition, pp. 291-334; and J. Am. Chem. Soc. Vol. 73, pp. 3100 (1951), according to the conventional methods, as described in, cited above, RD38957, items XVII through XX and RD40145, item XXII.

### EXAMPLES

The present invention will be exemplarily described based on examples but embodiments of this invention are by no means limited to these examples.

### Example 1

### Preparation of Tabular Grain Emulsion Em-1

Tabular silver halide emulsion Em-1 was prepared in accordance with the following procedure.

Nucleation Process

A 28.8 lit. aqueous solution containing 162.8 g of oxidized gelatin A (methionine content of 0.3 μmol) and 23.6 g of potassium bromide was maintained at 20° C. in a reaction vessel and adjusted to a pH of 1.90 using an aqueous 0.5 mol/l sulfuric acid solution, while stirring at a high speed using a mixing stirrer, as described in JP-A No. 62-160128. Thereafter, the following solutions, S-01 and X-01 were added by double jet addition in one minute to perform nucleation and then, solution G-01 was further added thereto.

S-01 Solution: 205.7 ml of 1.25 mol/l aqueous silver nitrate solution,

X-01 Solution: 205.7 ml of 1.25 mol/l aqueous potassium bromide solution,

G-01 Solution: 795 ml of aqueous solution containing 120.5 g of gelatin A and 8.8 ml of a 10% methanol solution of surfactant (A).

Surfactant A: HO(CH₂CH₂O)m[CH(CH₃)CH₂O]_{2O}(CH₂CH₂O)nH (m+n=10)

Ripening Process

After completion of the nucleation process, the temperature was raised to 600° C. in 45 min. and then, the pAg was adjusted to 9.0. Then, the reaction mixture was adjusted to a pH of 9.3 by adding 224.4 ml of an aqueous solution containing 29.2 g of ammonia and 709.3 ml of an aqueous potassium hydroxide solution, and after being maintained for 6 min., the pH was adjusted to 6.1.

Growth Process

After completion of the ripening process, solutions S-02 and X-02 were added by double jet addition at an accelerated flow rate (five times faster at the end than at the start), while maintaining the pAg at 9.0.

S-02 Solution: 2620 ml of 1.25 mol/l aqueous silver nitrate solution,

X-01 Solution: 2620 ml of 1.25 mol/l aqueous potassium bromide solution.

After completion of addition of respective solutions, the resulting emulsion was desalted by the convention washing method, and alkali-processed inert gelatin B (methionine content of 50.0 μmol/g) was added thereto and dispersed. The thus obtained emulsion was designated as seed emulsion T-A.

Subsequently, the foregoing tabular seed emulsion T-A was grown in accordance with the following procedure to prepare tabular grain emulsion Em-1, in which the mixing stirrer, as described in JP-A No. 62-160128 was used, and to remove soluble components from the reaction mixture by means of ultrafiltration was employed an apparatus described in JP-A No. 10-339923. Thus, to an aqueous 1% gelatin solution containing 0.123 mol. equivalent tabular seed emulsion T-A and 0.65 ml of a 10% methanol solution of the foregoing surfactant A, water and gelatin B were added to make 10 lit., then, the following solutions S-11 and X-11 were added by double jet addition at an accelerated flow rate (11 times faster at the end than at the start) over a period of 80 min., while soluble components in the reaction mixture were removed by ultrafiltration to maintain the reaction mixture at a constant volume.

S-11 Solution: 2432 ml of 1.75 mol/l aqueous silver nitrate solution,

X-11 Solution: 2432 ml of 1.741 mol/l potassium bromide and 0.009 mol/l potassium iodide aqueous solution.

The reaction mixture was further subjected to ultrafiltration over a period of 30 min. to remove 4.0 lit. of soluble components from the reaction mixture. Thereafter, the following solution S-12 was added thereto at a decreasing rate (0.28 time from start to finish) over a period of 17 min., followed by adjusting the pAg to 8.6.

S-12 Solution: 323 ml of 1.75 mol/l aqueous silver nitrate solution

Subsequently, solutions I-11 and Z-11 were added and after adjusting to a pH of 9.3 and being maintained for 6 min., the pH was adjusted to 5.0 with an aqueous acetic acid solution and the pAg was adjusted to 9.4 with an aqueous potassium bromide solution:

I-11 Solution: aqueous solution containing 16.0 g of sodium p-iodoacetoamidobenzenesulfonate,

Z-11 Solution: aqueous solution containing 5.6 g of sodium sulfite.

Then, the following solutions S-13 and X-13 were added at an accelerated flow rate (2.3 times faster at the end than at the start) over a period of 15 min, while soluble components in the reaction mixture were removed by ultrafiltration to maintain the reaction mixture at a constant volume.

S-13 Solution: 363 ml of aqueous 1.75 mol/l silver nitrate solution,

X-13 Solution: 363 ml of aqueous 1.663 mol/l potassium bromide and 0.088 mol/l potassium iodide solution.

Thereafter, the following solution S-14 was added thereto at a decreasing rate (0.28 time from start to finish) over a period of 15 min., followed by adjusting the pAg to 8.4.

S-14 Solution: 242 ml of 1.75 mol/l aqueous silver nitrate solution

Subsequently, the following solutions S-15 and X-15 were added by double jet addition at an accelerated flow rate (1.03 times fast at the end than at the start) over a period of 24 min., followed by adjusting the pAg to 9.4 with an aqueous potassium bromide solution. Then, the following solutions S-16 and X-16 were added by double jet addition at an accelerated flow rate (1.33 times fast at the end than at the start) over a period of 17 min.

S-15 Solution: 202 ml of aqueous 1.75 mol/l silver nitrate solution,

X-15 Solution: 202 ml of aqueous 1.663 mol/l potassium bromide and 0.088 mol/l potassium iodide solution.

S-16 Solution: 404 ml of aqueous 1.75 mol/l silver nitrate solution,

X-16 Solution: 404 ml of aqueous 1.75 mol/l potassium bromide solution.

After completion of addition, aqueous solution containing 120 g of chemically modified gelatin (in which the amino group was phenylcarbamoyled at a modification percentage of 95%) was added to perform desalting and washing, and then gelatin was further added and dispersed, followed by adjusting the pH and pAg to 5.8 and 8.9, respectively, at 40° C.

The thus prepared emulsion was subjected to chemical sensitization in the following manner. A part of the emulsion was dissolved with heating at a temperature 55° C. Sensitizing dyes (S-6), (S-8) and (S-10) described in JP-A 2002-72396 were added thereto in amounts of 6.0×10⁻⁵ mol, 5.0×10⁻⁴ mol and 6.0×10⁻⁵ mol per mol of silver halide, respectively, in the form of a 5 wt % methanol solution. After 20 min., 1.5×10⁻⁶ mol of selenium sensitizer (Se-1), 5.0×10⁻⁶ mol of sodium thiosulfate pentahydrate and a mixture of 2.0×10⁻⁶ mol of chloroauric acid and 2.5×10⁻⁴ mol of potassium thiocyanate were added in that order at 10 min. intervals and ripened until reached an optimal sensitivity. After completion of ripening, stabilizers (ST-1) and (AF-3) were further added in an amount of 3.0×10⁻³ mol and 5.0×10⁻⁵ mol per mol silver halide, respectively and the emulsion was cooled to 35° C. and solidified to obtain emulsion Em-1.

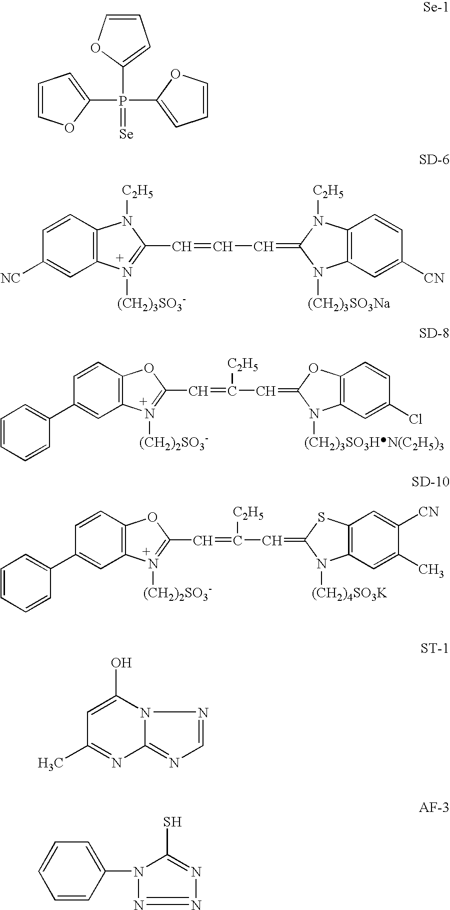

### Preparation of Tabular Grain Emulsion Em-2

To an aqueous 1% gelatin solution containing 0.123 mol. equivalent tabular seed emulsion T-A and 0.65 ml of a 10% methanol solution of the foregoing surfactant A, water and gelatin A used in the seed grain emulsion were added to make 10 lit., then, the following solutions S-11 and X-11 were added by double jet addition at an accelerated flow rate (11 times faster at the end than at the start) over a period of 60 min., while soluble components in the reaction mixture were removed by ultrafiltration to maintain the reaction mixture at a constant volume.

S-11 Solution: 1189.5 ml of 1.75 mol/l aqueous silver nitrate solution

X-11 Solution: 1189.5 ml of aqueous 1.741 mol/l potassium bromide solution.

The reaction mixture was further subjected to ultrafiltration over a period of 30 min. to remove 5.5 lit. of soluble components from the reaction mixture. Thereafter, the following solution S-12 was added thereto at a decreasing rate (0.28 time from start to finish) over a period of 17 min., then, the pAg was adjusted to 8.6.

S-12 Solution: 323 ml of 1.75 mol/l aqueous silver nitrate solution

Then, the following solutions S-13 and X-13 were added at a constant flow rate over a period of 15 min, while soluble components in the reaction mixture were removed by ultrafiltration to maintain the reaction mixture at a constant volume.

S-13 Solution: 100.9 ml of aqueous 1.75 mol/l silver nitrate solution,

X-13 Solution: 100.9 ml of aqueous 1.697 mol/l potassium bromide and 0.053 mol/l potassium iodide solution.

Thereafter, the following solution S-14 was added thereto at a-decreasing rate (0.28 time from start to finish) over a period of 15 min., followed by adjusting the pAg to 8.4.

Subsequently, the following solutions I-11 and Z-11 were added and after adjusting to a pH of 9.3 and being maintained for 6 min., the pH was adjusted to 5.7 with an aqueous acetic acid solution and the pAg was adjusted to 9.4 with an aqueous potassium bromide solution:

I-11 Solution: aqueous solution containing 64.1 g of sodium p-iodoacetoamidobenzenesulfonate,

Z-11 Solution: aqueous solution containing 22.2 g of sodium sulfite.

Subsequently, the pAg was adjusted to 9.4 using a 3.50 mol/l potassium bromide solution.

Subsequently, the following solutions S-15 and X-15 were added by double jet addition at an accelerated flow rate (2.6 times fast at the end than at the start) over a period of 61 min., followed by adjusting the pAg to 9.4 with an aqueous potassium bromide solution. Then, the following solutions S-16 and X-16 were added by double jet addition at a constant flow rate over a period of 4 min.

S-15 Solution: 433 ml of aqueous 1.75 mol/l silver nitrate solution,

X-15 Solution: 433 ml of aqueous 1.663 mol/l potassium bromide and 0.088 mol/l potassium iodide solution.

S-16 Solution: 121 ml of aqueous 1.75 mol/l silver nitrate solution,

X-16 Solution: 121 ml of aqueous 1.75 mol/l potassium bromide solution.

After completion of addition, aqueous solution containing 120 g of chemically modified gelatin (in which the amino group was phenylcarbamoyled at a modification percentage of 95%) was added to perform desalting and washing, and then gelatin was further added and dispersed, followed by adjusting the pH and pAg to 5.8 and 8.9, respectively, at 40° C.

The emulsion was subjected to chemical sensitization similarly to emulsion Em-1 to obtain emulsion Em-2.

### Preparation of Tabular Grain Emulsion Em-3

Silver halide emulsion (Em-3) comprising tabular grains having two twin planes was prepared in accordance with the following procedure.

Nucleation Process

A 28.3 lit. aqueous solution containing 122.0 g of alkali-processed inert gelatin B, 78.3 g of potassium bromide and 0.24 ml of 10 wt % surfactant A methanol solution was maintained at 30° C. in a reaction vessel, while stirring at a high speed using a mixing stirrer, as described in JP-A No. 62-160128. Thereafter, the following solutions, S-01 and X-01 were added by double jet addition in one minute to perform nucleation and then, solution G-01 was further added thereto.

S-01 Solution: 1860 ml of 1.90 mol/l aqueous silver nitrate solution,

X-01 Solution: 1860 ml of 1.25 mol/l aqueous potassium bromide solution,

G-01 Solution: 2564 ml of aqueous solution containing 200.0 g of gelatin A

Ripening Process

After completion of the nucleation process, the temperature was raised to 60° C. in 30 min. and then, 37 ml of an aqueous 28% ammonia solution. Then, the reaction mixture was adjusted to a pH of 9.5 with an aqueous 10% potassium hydroxide solution. After being ripened for 6 min., the pH was adjusted to 6.1 with an aqueous 56% acetic acid solution.

After completion of addition of respective solutions, the resulting emulsion was desalted by the convention washing method, and alkali-processed inert gelatin B (methionine content of 50.0 μmol/g) was added thereto and dispersed to obtain seed emulsion T-B.

Subsequently, the foregoing tabular seed emulsion T-B was grown in accordance with the following procedure to prepare tabular grain emulsion Em-3, in which the mixing stirrer, as described in JP-A No. 62-160128 was used, and an apparatus described in JP-A No. 10-339923 was employed to remove soluble components from the reaction mixture by means of ultrafiltration. Thus, to an aqueous 1% gelatin solution containing 0.123 mol. equivalent tabular seed emulsion T-A and 0.65 ml of a 10% methanol solution of the foregoing surfactant A, water and gelatin B were added to make 10 lit., then, the following solutions S-11 and X-11 were added by double jet addition at an accelerated flow rate (11 times faster at the end than at the start) over a period of 80 min., while soluble components in the reaction mixture were removed by ultrafiltration to maintain the reaction mixture at a constant volume.

S-11 Solution: 2432 ml of 1.75 mol/l aqueous silver nitrate solution,

X-11 Solution: 2432 ml of 1.741 mol/l potassium bromide and 0.009 mol/l potassium iodide aqueous solution.

The reaction mixture was further subjected to ultrafiltration over a period of 30 min. to remove 4.0 lit. of soluble components from the reaction mixture. Thereafter, the following solution S-12 was added thereto at a decreasing rate (0.28 time from start to finish) over a period of 17 min., followed by adjusting the pAg to 8.6.

S-12 Solution: 323 ml of 1.75 mol/l aqueous silver nitrate solution

Subsequently, solutions I-11 and Z-11 were added and after adjusting to a pH of 9.3 and being maintained for 6 min., the pH was adjusted to 5.0 with an aqueous acetic acid solution and the pAg was adjusted to 9.4 with an aqueous potassium bromide solution:

I-11 Solution: aqueous solution containing 16.0 g of sodium p-iodoacetoamidobenzenesulfonate,

Z-11 Solution: aqueous solution containing 5.6 g of sodium sulfite.

Then, the following solutions S-13 and X-13 were added at an accelerated flow rate (2.3 times faster at the end than at the start) over a period of 15 min, while soluble components in the reaction mixture were removed by ultrafiltration to maintain the reaction mixture at a constant volume.

S-13 Solution: 363 ml of aqueous 1.75 mol/l silver nitrate solution,

X-13 Solution: 363 ml of aqueous 1.663 mol/l potassium bromide and 0.088 mol/l potassium iodide solution.

Thereafter, the following solution S-14 was added thereto at a decreasing rate (0.28 time from start to finish) over a period of 15 min., followed by adjusting the pAg to 8.4.

S-14 Solution: 242 ml of 1.75 mol/l aqueous silver nitrate solution

Subsequently, the following solutions S-15 and X-15 were added by double jet addition at an accelerated flow rate (1.03 times fast at the end than at the start) over a period of 24 min., followed by adjusting the pAg to 9.4 with an aqueous potassium bromide solution. Then, the following solutions S-16 and X-16 were added by double jet addition at an accelerated flow rate (1.33 times fast at the end than at the start) over a period of 17 min.

S-15 Solution: 202 ml of aqueous 1.75 mol/l silver nitrate solution,

X-15 Solution: 202 ml of aqueous 1.663 mol/l potassium bromide and 0.088 mol/l potassium iodide solution.

S-16 Solution: 404 ml of aqueous 1.75 mol/l silver nitrate solution,

X-16 Solution: 404 ml of aqueous 1.75 mol/l potassium bromide solution.

After completion of addition, aqueous solution containing 120 g of chemically modified gelatin (in which the amino group was phenylcarbamoyled at a modification percentage of 95%) was added to perform desalting and washing, and then gelatin was further added and dispersed, followed by adjusting the pH and pAg to 5.8 and 8.9, respectively, at 40° C.

The thus prepared emulsion was subjected to chemical sensitization in the following manner. A part of the emulsion was dissolved with heating at a temperature 55° C. Sensitizing dyes (S-6), (S-8) and (S-10) described in JP-A 2002-72396 were added thereto in amounts of 3.0×10⁻⁵ mol, 2.5×10⁻⁴ mol and 3.0×10⁻⁵ mol per mol of silver halide, respectively, in the form of a 0.5 wt % methanol solution. After 20 min., 3.5×10⁻⁶ mol of selenium sensitizer (Se-1), 7.0×10⁻⁶ mol of sodium thiosulfate pentahydrate and a mixture of 2.0×10⁻⁶ mol of chloroauric acid and 2.5×10⁻⁴ mol of potassium thiocyanate were added in that order at 10 min. intervals and ripened until reached an optimal sensitivity. After completion of ripening, stabilizers (ST-1) and (AF-1) described in the foregoing patent document were added in an amount of 3.0×10⁻³ mol and 5.0×10⁻⁵ mol per mol of silver halide, respectively and the emulsion was cooled to 35° C. and solidified to obtain emulsion Em-3.

### Preparation of Tabular Grain Emulsion Em-4

Tabular grain emulsion (Em-4) was prepared similarly to Em-3, except that contents of the solutions I-11 and Z-11 were varied as below:

I-11 Solution: aqueous solution containing 64.1 g of sodium p-iodoacetoamidobenzenesulfonate,

Z-11 Solution: aqueous solution containing 22.2 g of sodium sulfite.

Thus prepared emulsions Em-1 to Em-4 are summarized in Table with respect to characteristics of silver halide grains.

TABLE 1

| | Av. | | | |
|---|---|---|---|---|
| | Grain | | | Dislocation |
| | Size*¹ | Av. Aspect | | Line*³ |
| Emulsion | (μm) | Ratio | Tabular Grain*² (%) | (%) |
| Em-1 | 2.0 | 10 | 84 | 20 |
| Em-2 | 2.0 | 16 | 98 | 70 |
| Em-3 | 1.5 | 6 | 70 | 15 |
| Em-4 | 1.5 | 6 | 70 | 50 |

*¹equivalent circular diameter
*²percentage of tabular grains having an aspect ratio of 4 to 500, based on total grain projected area
*³percentage by number of grains having at least 30 dislocation lines per grain in the fringe portion

### Preparation of Photographic Material

Emulsion (Em-1) was dispersed at 40° C. and dithiacyclooctanol (T-1) was added to the emulsion in an amount shown in Table 2. Further thereto, hydroxybenzene was added in an amount of 3.0×10⁻³ mol/mol AgBr. After ripening for 10 min., additive compounds were further added to prepare a coating solution as below. The addition amount of each compound was represented in term of g/m²

| M-1 | 0.071 (g/m²) |
|---|---|
| M-2 | 0.073 |
| CM-2 | 0.013 |
| DI-2 | 0.004 |
| DI-3 | 0.003 |
| OIL-1 | 0.27 |
| SA-2 | 0.008 |
| AS-3 | 0.043 |
| Gelatin | 1.35 |

The thus prepared coating solution was added with hardener (H-2) and coated on a subbed triacetate film support to obtain a monolayer sample 101. Samples 102 to 105 were prepared similarly to sample 101, provided that emulsion Em-1 was replaced by Em-2 and the amount of T-1 was varied as shown in Table 2.

Samples 106 to 110 were prepared similarly to sample 101, provided that the following additive compounds were added and the amount of T-1 was varied as shown in Table 2.

| M-1 | 0.15 (g/m²) |
|---|---|
| CM-1 | 0.062 |
| CM-2 | 0.030 |
| DI-2 | 0.032 |
| OIL-1 | 0.28 |
| AS-2 | 0.005 |
| AS-3 | 0.045 |
| Gelatin | 1.000 |

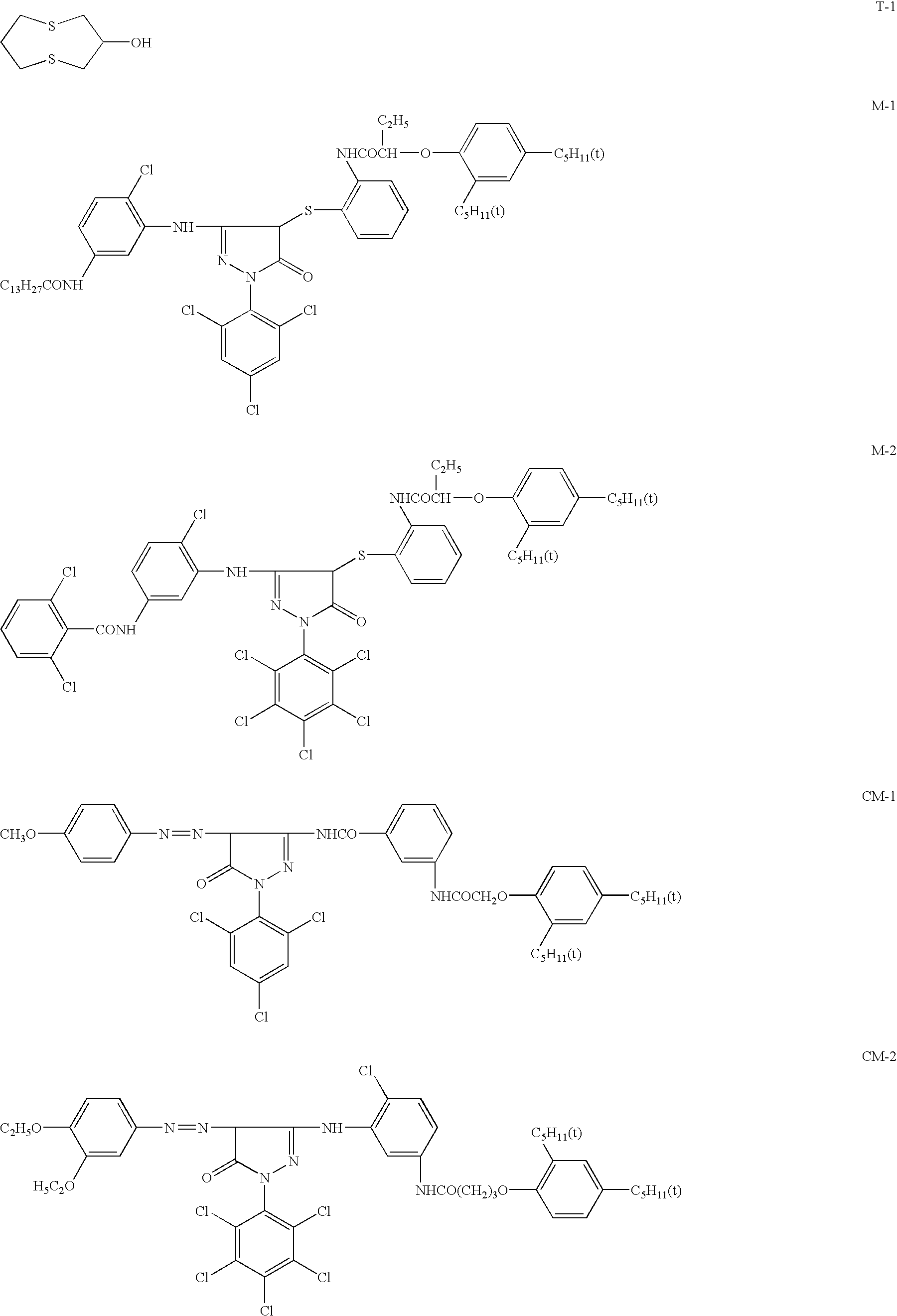 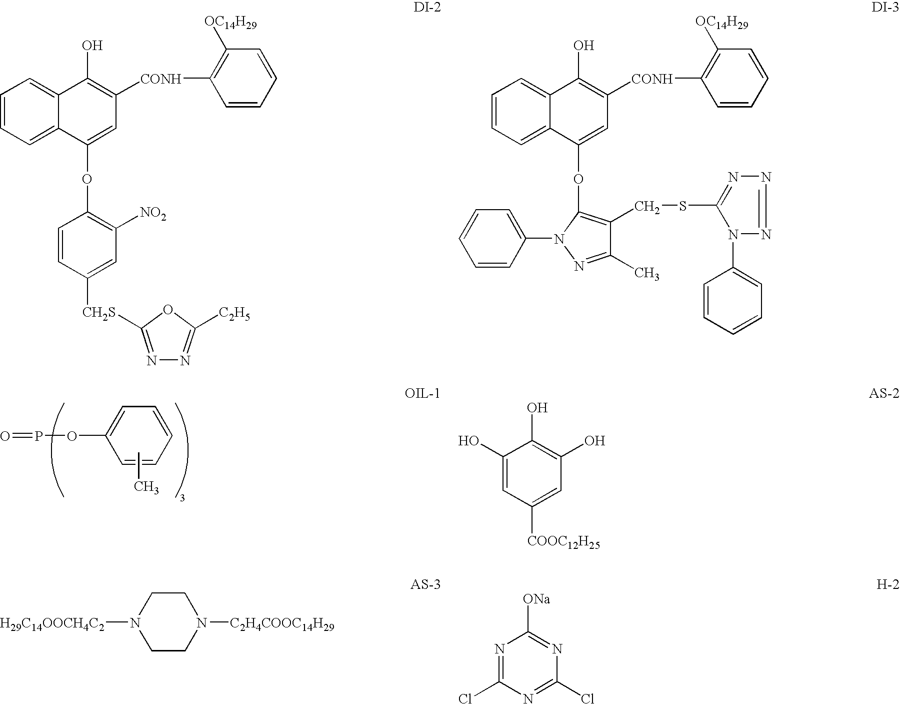 TABLE 2

| Sample | | |
|---|---|---|
| No. | Emulsion | T-1 (mmol/mol · AgBr) |
| 101 | Em-1 | 0.3 |
| 102 | Em-2 | 0 |
| 103 | Em-2 | 0.3 |
| 104 | Em-2 | 1 |
| 105 | Em-2 | 2 |
| 106 | Em-3 | 0.3 |
| 107 | Em-4 | 0 |
| 108 | Em-4 | 0.3 |
| 109 | Em-4 | 1 |
| 110 | Em-4 | 2 |

### Preparation of Sample 101′ to 110′

Color photographic material samples 101′ to 110′ were respectively prepared similarly to the foregoing samples 101 to 110, provided that emulsions Em-1 to Em-4 were respectively replaced by emulsions Em-1′ to Em-2′.

Emulsions Em-1′ to Em-4′ were respectively prepared similarly to Em-4, provided that, 18 min. after adding sensitizing dyes, calcium nitrate was added in an amount of 7.0×10⁻³ mol per mol of silver halide and after 2 min., chemical sensitization was performed similarly to Em-1 to Em-4.

### Evaluation of Photographic Performance

The thus prepared samples were each exposed to white light through an optical stepped wedge at an exposure of 1.6 CMS for 1/200 sec. and then processed in accordance with the color process described in JP-A No. 10-123652, paragraph Nos. [0220] through [0227].

Processed samples were subjected to densitometry using green light to determine sensitivity. Sensitivity was defined as the reciprocal of exposure giving a density of 0.2 plus minimum density. Sensitivities of samples 101 to 105 and 101′ to 105′ were represented by a relative value₁ based on the sensitivity of sample 101 being 100. Sensitivities of samples 106 to 110 and 106′ to 110′ were also represented by a relative value, based on the sensitivity of sample 106 being 100. A greater value indicates a higher sensitivity.

Further, after aged at 55° C. for 5 days, photographic material samples were evaluated with respect to fogging (or minimum density). Results are shown in Table 3.

TABLE 3

| Sample | Ca-Salt | | | | |
|---|---|---|---|---|---|
| No. | Addition | Sensitivity | Fog | Fog After Aged | Remark |
| 101 | No | 100 | 0.23 | 0.50 | Comp. |
| 101′ | Yes | 100 | 0.16 | 0.20 | Inv. |
| 102 | No | 110 | 0.20 | 0.22 | Comp. |
| 102′ | Yes | 110 | 0.16 | 0.19 | Comp. |
| 103 | No | 136 | 0.24 | 0.50 | Comp. |
| 103′ | Yes | 136 | 0.17 | 0.20 | Inv. |
| 104 | No | 133 | 0.26 | 0.51 | Comp. |
| 104′ | Yes | 133 | 0.17 | 0.20 | Inv. |
| 105 | No | 121 | 0.30 | 0.56 | Comp. |
| 105′ | Yes | 121 | 0.18 | 0.23 | Inv. |
| 106 | No | 100 | 0.17 | 0.30 | Comp. |
| 106′ | Yes | 100 | 0.14 | 0.15 | Inv. |
| 107 | No | 105 | 0.15 | 0.22 | Comp. |
| 107′ | v | 105 | 0.14 | 0.15 | Comp. |
| 108 | No | 124 | 0.17 | 0.33 | Comp. |
| 108′ | Yes | 124 | 0.14 | 0.15 | Inv. |
| 109 | No | 130 | 0.18 | 0.38 | Comp. |
| 109′ | Yes | 130 | 0.15 | 0.17 | Inv. |
| 110 | No | 130 | 0.21 | 0.49 | Comp. |
| 110′ | Yes | 130 | 0.15 | 0.17 | Inv. |

As can be seen from Table 3, it was proved that silver halide emulsions according to this invention resulted in enhanced sensitivity and superior thermal storage stability.

What is claimed is:

1. A silver halide emulsion comprising silver halide grains, wherein the silver halide emulsion is subjected to spectral sensitization with a sensitizing dye and further subjected to chemical sensitization with a chemical sensitizer, the emulsion contains at least one alkaline earth metal salt selected from the group consisting of a magnesium salt, calcium salt and a strontium salt and a compound having a function of permitting injection of at least one electron into silver halide upon reaction with an oxidized sensitizing dye or a valence band hole.

2. The silver halide emulsion of claim 1, wherein the emulsion contains at least one alkaline earth metal salt selected from the group of calcium nitrate, calcium chloride, magnesium nitrate, magnesium chloride and strontium nitrate.

3. The silver halide emulsion of claim 1, wherein said compound having a function of permitting injection of at least one electron into silver halide upon reaction with an oxidized sensitizing dye or a valence band hole is an organic compound capable of forming an (m+n)-valent cation from an n-valent cation radical with an intramolecular cyclization reaction or intramolecular transannular reaction, in which n and m are each an integer of 1 or more.

4. The silver halide emulsion of claim 1, wherein said compound having a function of permitting injection of at least one electron into silver halide upon reaction with an oxidized sensitizing dye or a valence band hole is a compound forming a bivalent cation from a univalent cation radical with an intramolecular cyclization reaction or intramolecular transannular reaction.

5. The silver halide emulsion, wherein at least 70% of a total grain projected area is accounted for by tabular grains having an aspect ratio of 4 to 100 and at least 50% by number of silver halide grains is accounted for tabular grains having dislocation lines of at least 30 per grain in the fringe portion of the grains.

6. The silver halide emulsion of claim 1, wherein the sensitizer is a chalcogen sensitizer.

7. The silver halide emulsion of claim 1, wherein the emulsion contains a hydroxybenzene compound.

8. A silver halide color photographic material comprising a support having thereon a red-sensitive layer, a green-sensitive layer, a blue-sensitive layer and a light-insensitive layer, wherein at least one of the red-sensitive layer, green-sensitive layer and blue-sensitive layer comprises a silver halide emulsion, as claimed in claim 1.

9. A method of preparing a silver halide emulsion comprising silver halide grains, the method comprising the steps of:
(a) adding a sensitizing dye to the emulsion to perform spectral sensitization,
(b) adding at least one alkaline earth metal salt selected from the group consisting of a magnesium salt, a calcium salt and a strontium salt to the emulsion,
(c) adding a chemical sensitizer to the emulsion to perform chemical sensitization, and
(d) adding to the emulsion a compound having a function of permitting injection of at least one electron into silver halide upon reaction with an oxidized sensitizing dye or a valence band hole.

10. The method of claim 9, wherein in step (b), the alkaline earth metal salt is added in an amount of 1×10⁻⁴ to 1×10⁻² mol per mol of silver halide.

11. The method of claim 9, wherein in step (c), the chemical sensitizer is a chalcogen sensitizer.

12. The method of claim 11, where the chalcogen sensitizer is selected from the group consisting of sulfur sensitizers and selenium sensitizers.
